(19) United States
(12) Patent Application Publication
(10) Pub. No.: US 2024/0001257 A1
(43) Pub. Date: Jan. 4, 2024

(54) System and Method of Treating Brines

(71) Applicant: Bruce Smith, Mandurah (AU)

(72) Inventor: Bruce Smith, Mandurah (AU)

(21) Appl. No.: 18/252,696

(22) PCT Filed: Nov. 11, 2021
(86) PCT No.: PCT/AU2021/051340

§ 371 Date: May 11, 2023

(30) Foreign Application Priority Data
Nov. 11, 2020 (AU) 2020904137

(51) Int. Cl. B01D 9/00; B01D 9/02; C02F 1/469; C25B 1/04

(52) U.S. Cl. CPC B01D 9/0013; B01D 9/0063; B01D 9/02; C02F 1/4691; C25B 1/04

(57) ABSTRACT

A method of treating brines (10) comprising the steps of: pre-cooling the brines using a stream medium before further cooling the brines using a refrigerant. This further cooling of the brines continues until a first temperature equal to a eutectic freezing point of a mineral salt suspended in the brines is reached, such that the brines are transformed into an ice slurry. The ice is then separated from the ice slurry for use as part of the pre-cooling step. The remainder of the ice slurry is filtered to recover crystallised mineral salts suspended therein. A system for performing the method is also described.

### FIELD OF THE INVENTION

The invention relates to a system and method of treating brines. The invention is particularly, but not exclusively, suited to recovering targeted salts from brines.

### BACKGROUND TO THE INVENTION

The following discussion of the background to the invention is intended to facilitate an understanding of the present invention. However, it should be appreciated that the discussion is not an acknowledgment or admission that any of the material referred to was published, known or part of the common general knowledge in any jurisdiction as at the priority date of the application.

Traditionally, brines have been treated at an industrial scale through the use of evaporation ponds. These evaporation ponds are designed to hold the brines in place at an area exposed to the elements which facilitate the evaporation of the water component of the brine, leaving the mineral salt entrained therein to remain for later collection.

The problems faced by evaporation ponds are many. However, of key significance in the modern era, is the large tracts of land that they require. As the need to process brines can occur in remote locations, it is not improbable that land allocated for use as an evaporation pond may include sites of cultural or historical significance to first nations people.

Evaporation ponds also present environmental problems. While it is a common environmental problem of large-scale mineral processing activity that the site must be remediated on cessation of mining, evaporation ponds also pose an additional environmental risk by virtue of its very nature. To elaborate, the mineral salt to be processed may pose environmental concerns that require the brines to be shielded from the ground by way of a lining. Failure of the lining, for whatever reason, can then result in environmental contamination.

An additional problem of evaporation ponds is time. By relying on the water evaporation to dehydrate and concentrate brine streams held in the evaporation ponds, the time before recovery of mineral salts suspended therein can be undertaken varies (not to mention that the evaporated water is lost to the atmosphere). Too reduce the impact of this variance, the accepted solution is to use more evaporation ponds on a staggered production schedule (thereby resulting in even greater loss of evaporated water to the atmosphere).

It is therefore an object of the present invention to provide an alternative means by which to process brines so as to recover targeted mineral salts in a manner that overcomes, or at least ameliorates in part, one or more of the aforementioned problems.

### SUMMARY OF THE INVENTION

Throughout this document, unless otherwise indicated to the contrary, the terms “comprising”, “consisting of”, and the like, are to be construed as non-exhaustive, or in other words, as meaning “including, but not limited to”.

The term “brines” as used in this specification is defined as salt or salts and/or a mineral or minerals in any concentration, whether homogenous or heterogenous and whether dissolved and/or suspended in an aqueous medium. Furthermore, the “brines” can be naturally occurring or processed in part or completely manufactured. For the purposes of the following description, however, and unless the context suggests the broader definition of the previous sentence, the term “brines” will be used as a reference to a high concentration of a mineral salt saturated in water. While the mineral salt may be common salt (NaCl), the invention is not limited to this and any other salt on the periodic table may be treated using the invention.

In accordance with a first aspect of the present invention there is a method of treating brines comprising the steps of:
pre-cooling the brines using a stream medium;
further cooling the brines using a refrigerant to a first temperature equal to a eutectic freezing point of a mineral salt suspended in the brines so as to transform the brines into an ice slurry;
separating the ice from the ice slurry for use as part of the pre-cooling step;
filtering the remainder of the ice slurry to recover crystallised mineral salts suspended therein.

The method of treating brines may further include a step of pre-treating the brines. Various forms of pre-treatment are suggested, including chemical treatment via gaseous, solid or aqueous addition so as to cause chemical reactions that change the composition of the brine, magnetic separation, magnetism treatment, electrochemical treatment, radiation treatment, UV light treatment, sound wave treatment, centrifugal, centrical or other mechanical separation processes, screening spraying or other processes which render the brines more appropriate and suitable to be processed by the invention.

The method may further include the step of conveying the brines through a vessel used to further cool the brines using the refrigerant so as to prevent the slurry from solidifying in place. The mechanisms used to effect this conveyance may be a plurality of offset static walls or a water screw or scrapers.

The method may further include the step of extracting hydrogen from the brines by electrolysis. The electricity needed to perform this step may be generated from a hydro electric generator.

In accordance with a second aspect of the present invention there is a system of treating brines comprising:
a static heat exchanger comprising a container having a hollow internal area and at least one conduit passing therethrough;
an evaporator having an inner wall and an outer wall;
refrigerating means;
a discharge tank; and
a filter
   where brines passing through the at least one conduit are pre-cooled by ice delivered to the hollow internal area before being delivered to the evaporator and where the refrigerating means delivers refrigerant to the area between the inner wall and an outer wall, the refrigerant operable to cool the area defined by the inner wall to a first temperature equal to a eutectic freezing point of a mineral salt suspended in the brines and thereby transform the brines into an ice slurry; and where, when the ice slurry is delivered to the discharge tank, the ice is separated therefrom for delivery to the hollow internal area of the static heat exchanger and the remainder of the ice slurry is filtered by the filter to recover crystallised mineral salts suspended therein.

The system of treating brines may further include a pre-treatment vessel incorporating a chemical doser, the chemical doser operable to pre-treat brines passing through the pre-treatment vessel with an acid before delivery to the static heat exchanger.

The system of treating brines may also incorporate a hydro electric generator, the hydro electric generator operable to generate power from brines before the brines are delivered to the static heat exchanger. The power generated by the hydro electric generator may be used to separate hydrogen in the brines by way of electrolysis.

The system may be adapted to include multiple evaporators and/or discharge tanks grouped into evaporation circuits, each evaporator circuit adapted to cool the brine that passes therethrough to a eutectic freezing point of a differing mineral salt suspended in the brines and filter out the crystallised mineral salts and/ice generated in each evaporator circuit.

The evaporator may include slurry means for conveying the brines through the internal area defined by the internal wall of the evaporator and thereby prevent the slurry from solidifying in place. The slurry means may be any one of the following: a plurality of offset static walls; a water screw; scrapers.

The evaporator may be installed in a modularised form factor. In this manner, multiple evaporators may be installed in a larger structure having a set form factor and standard interface. Similarly, one or more discharge tanks may be adapted to meet the same set form factor and standard interface of the larger structure used to house multiple evaporators.

### BRIEF DESCRIPTION OF THE DRAWINGS

The invention will now be described, by way of example only, with reference to the accompanying drawings, in which:

FIG. 1 is a flowchart of the method of treating brines according to a first aspect of the present invention.

FIG. 2 is a schematic representation of the system used to perform the method shown in FIG. 1.

FIG. 3 is a schematic representation of a system used to perform a method of treating brines according to a second aspect of the present invention. The schematic representation is limited to the elements of the system that vary from those shown in FIG. 2.

FIG. 4 is a schematic representation of a system used to perform a method of treating brines according to a third aspect of the present invention. The schematic representation is again limited to the elements of the system that vary from those shown in FIG. 2.

### PREFERRED EMBODIMENTS OF THE INVENTION

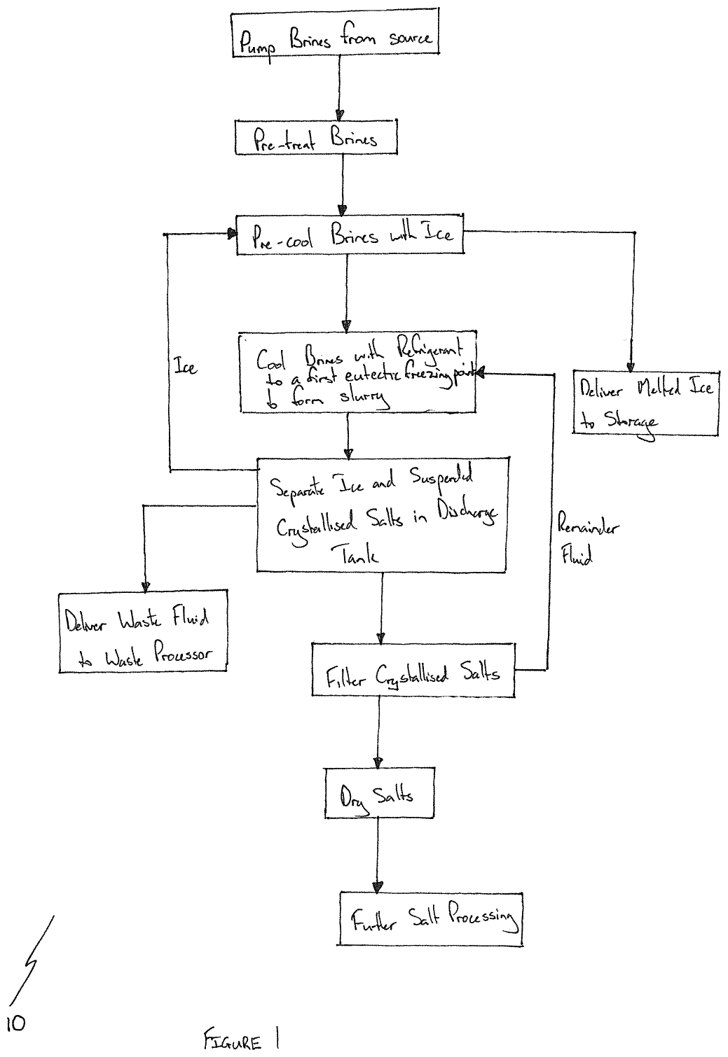

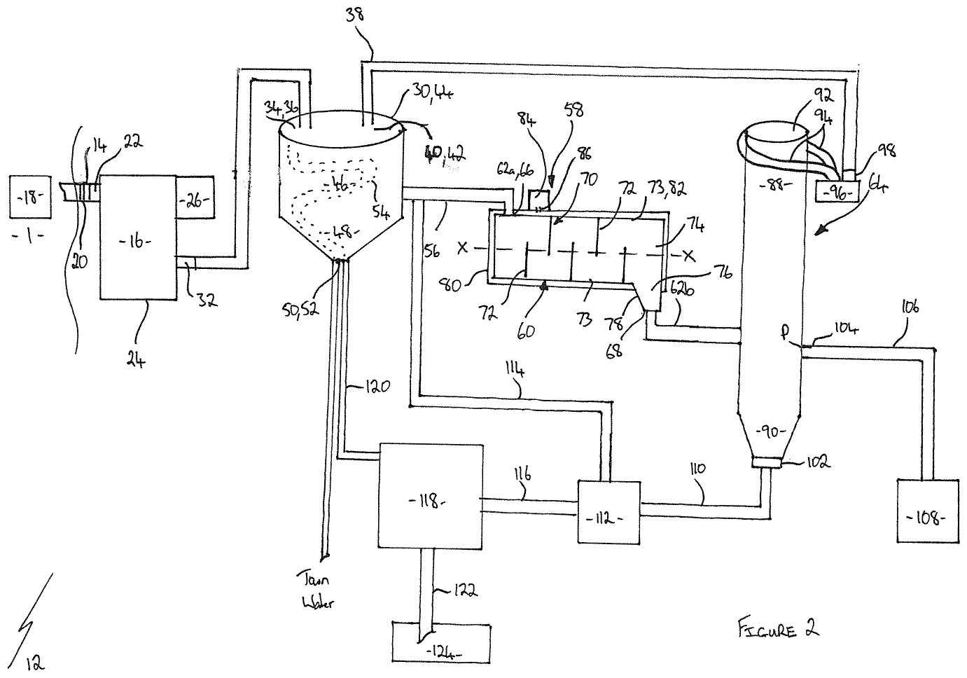

In accordance with a first embodiment of the invention there is a method of treating brines 10 as shown in FIG. 1. In order to understand the method 10, its first necessary to understand the system used to perform the method. This system is shown schematically in FIG. 2.

The physical apparatus takes the form of circuit 12. Circuit 12 commences with a source conduit 14 to a pre-treatment vessel 16. A high pressure pump 18 operates to convey brines from the ground 1 through the source conduit 14.

A Pelton wheel 20 is placed in-situ within the source conduit 14. The Pelton wheel 20 is coupled to a hydro power generator (not shown). A compensatory pump 22 is connected to the source conduit 14 downstream of the Pelton wheel 20.

The pre-treatment vessel 16 in this embodiment takes the form of containment vessel 24. Attached to the containment vessel 24 is a dosing pump 26.

A further conduit 28 extends between the pre-treatment vessel 14 and a static heat exchanger 30. In this embodiment, an additional pump 32 is used to move fluid through the further conduit 28.

The further conduit 28 connects to the static heat exchanger 16 on a first side 34, hereafter referred to as the tube side, at a first header 36. An ice conduit 38 connects to the static heat exchanger 16 on a second side 40, hereafter referred to as the external side, at a second header 42.

The static heat exchanger 30 takes the form of a container 44 having an internal area. The container 44 has a first segment 46 and a second segment 48. The first segment 46 is cylindrical in shape. The second segment 48 is conical in shape leading to an apex 50. A flow valve 52 is located in the apex 50.

A plurality of tubes 54 extend from the first header 36 within the internal area eventually terminating at the flow valve 52. In its preferred alignment, when in operation, the flow valve 52 is located beneath the first and second headers 36, 42 so as to facilitate gravity feed.

A third conduit 56 connects the static heat exchanger 30 to at least one evaporator circuit 58. Each evaporator circuit 58 comprises a plurality of evaporator modules 60, feed and discharge lines 62 and at least one discharge tank 64.

A central feed line 62a connects the third conduit 56 to each evaporator module 60 at a first position 66. Each evaporator module 60 connects to a discharge line 62b at a second position 68.

Each evaporator module 60 has an internal surface (not shown). The internal surface of the evaporator modules 60 are treated with a super-hydrophobic coating designed to minimise mechanical friction and wear.

Additionally, each evaporator module 60 has a central longitudinal axis X-X.

The evaporator module 60 has slurry means 70. In this embodiment, the slurry means 70 takes the form of a plurality of static walls 72 extending from internal surface 73.

Each static wall 72 extends from the internal surface 72 in a direction substantially perpendicular to the central longitudinal axis X-X. At the same time, the static walls 72 are each offset relative to the central longitudinal axis and arranged such as to define a sinusoidal flow path within the area defined by the internal surface 73.

The evaporator module 60 has a discharge end 74. The discharge end 74 has a projection 76. The projection 76 has a sloped side 78 located after the last static wall 72 in the sinusoidal flow path. The second position 68 forms the part of the projection 76 to which the sloped side 78 leads.

Each evaporator module 60 has an external wall 80 and an internal wall 82. The external wall 80 and the internal wall 82 are spaced from each other. A refrigerant injector 84 is in fluid communication with the space between the external wall 80 and the internal wall 82. A refrigerant discharge port 86 is also in fluid communication with the space between the external wall 80 and the internal wall 82.

Each discharge line 62b connects at least one evaporator module 60 to a discharge tank 64. The discharge tank 64 is sized to a volume commensurate with the intended system flow rate and % volume of ice that may be generated.

The discharge tank 64 has a cylindrical segment 88 and a conical section 90. The discharge tank 64 is arranged such that the cylindrical segment 88 sits atop the conical section 90 in its intended operational alignment. In this manner, brines conveyed to the discharge tank 64 are first received into the cylindrical segment 88.

The discharge tank 64 has an open top 92. Surrounding the open top 92 is at least one sloped launder 94. Each sloped launder 94 is arranged to match the contour of external side of the cylindrical segment 88 and eventually terminate in a pump well 96.

The pump well 96 ideally houses a peristaltic pump 98. The peristaltic pump 98 operates to convey ice separated by the discharge tank 64 back along the ice conduit 38 to the external side 40 of the static heat exchanger 30.

Located in the apex 100 of the conical section 90 is a discharge valve 102.

A waste outlet 104 is located in the discharge tank 64 at point P, being approximately one-third the total height of the discharge tank 24 as determined from discharge valve 102. A waste conduit 106 extends from the waste outlet 104 to a waste processor 108.

A first solid conduit 110 connects the discharge valve 102 to a filter 112. In this embodiment, the filter 112 takes the form of a wedge wire screen.

A recycle conduit 114 connects the filter 112 to the third conduit 56.

A second solid conduit 116 connects the filter 112 to a salt dryer 118. A heat recovery conduit 120 also connects the static heat exchanger 30 with the salt dryer 118. The salt dryer 118 takes the form of a belt dryer.

A salt conduit 122 extends from the salt dryer 48 to a salt processing plant 124.

The method will now be described in the context of its intended use with the aforementioned system.

High pressure pump 18 operates to pump brines located in ground 1 through source conduit 14. Brines travelling along the source conduit 14 pass through the Pelton wheel 20 thereby causing the Pelton wheel 20 to rotate. Rotation of the Pelton wheel 20 provides kinetic energy that the hydro power generator is able to convert to electrical energy.

Brines that have passed through the Pelton wheel 20 lose velocity relative to the brines still to pass through the Pelton wheel 20. For this reason, the compensatory pump 22 operates to return the brines that have passed through the Pelton wheel 20 to a commensurate velocity.

Ultimately, brines passing through the source conduit 14 are delivered to the pre-treatment vessel 16 where it is accumulated in the containment vessel 24. The brines accumulated in the containment vessel 24 are then treated by the dosing pump 26 with a set of pre-treatment chemicals. In this embodiment, the pre-treatment chemicals are an acid.

The pre-treated brines are then conveyed from the containment vessel 24 to the static heat exchanger 30 by way of further conduit 28. Additional pump 32 is used to effect this conveyance.

Brines flowing through the further conduit 28 pass through the first header 36 of the static heat exchanger 30. At this point, the brines pass from further conduit 28 to at least one of the tubes 54.

At the same time, ice from discharge tank 64 flows through ice conduit 38 to pass through second header 42. At this point, the ice occupies the space within the static heat exchanger 30 not taken up by the tubes 54. The end result is that each tube 54 is effectively encapsulated by ice.

It is to be noted that there is a significant temperature differential between the ice and the brines flowing through the tubes 54. This means that as the brines flow through the tubes 54, the ice starts to melt as it seeks to cool the brines. The brines that pass through the tubes 54 are hereafter described as pre-cooled brines.

As the ice melts, the reduced size of the ice and the effect of gravity combine to cause the reduced ice to further occupy intervening space surrounding the tubes 54 not otherwise taken up by incoming ice. The purified water generated from the melting ice pools in the second segment 48 just above the flow valve 52.

At periodic times, the flow valve 52 is opened so as to allow the purified water to flow therethrough ultimately to a water storage unit (not shown). In its preferred arrangement the water storage unit is connected to a town water source as an additional source of potable water.

The pre-cooled brines are then conveyed from the static heat exchanger by way of the third conduit 56. As the pre-cooled brines are conveyed along the third conduit 56, filtered brine is mixed therewith as will be further elaborated on hereafter.

The mixed pre-cooled brines exit the third conduit 56 into central feed line 62a. Branches extending from the central feed line 62a to each evaporator module operate to convey the mixed pre-cooled brines to at least one evaporator module 60.

It is to be noted here that on initiation of an evaporator circuit 58, refrigerant is used to cool each evaporator module 60. To elaborate, refrigerant injector 84 operates to dispense refrigerant into the space between the internal wall and external wall 82. In this embodiment, the refrigerant used is ammonia. Refrigerant then exits the space between the internal wall 80 and external wall 82 by way of refrigerant discharge port 86 so as to allow for new refrigerant to be injected.

The refrigerant interposed between the internal wall 80 and the external wall 82 emanates cold into the area defined by the internal surface 73 of the evaporator module 60.

This arrangement results in mixed pre-cooled brines beginning to freeze to a first eutectic freezing temperature as it enters the evaporator module 60 and travels therethrough. The benefit of this will be described in more detail below.

Brines passing through the evaporator module 60 follows the sinusoidal flow path defined by the static walls 72 to the discharge end 74. However, the cold applied to the area defined by the internal surface 73 by the refrigerant transforms the brines from a fluid to a slurry of fluid and ice.

While the intent of the invention is to transform the mixed pre-cooled brines into a slurry form, it is understood that portions of the mixed pre-cooled brines may solidify from time to time. However, solidified brines are intended to accumulate against the static walls 72 and thus assist in further defining the sinusoidal flow path for later brines.

The brines, in slurry form, that arrives at the discharge end 74 is then subject to gravitational forces. These forces cause the slurried brines to drop towards the sloped side 78. The angular nature of the sloped side 78 ensures that the slurried brines are channelled towards the discharge line 62b to which the evaporator module 60 is connected.

In this embodiment, the discharge lines 62b merge at a downstream point to form a single conduit for the slurried brine to the discharge tank 64.

The slurried brine dispensed into the discharge tank 64 separates into an ice component and a fluid component.

The ice component floats to the top of the discharge tank 64 where, due to it having an open top 92, overflows. The overflowing ice is then captured by a sloped launder 94. The nature of the sloped launder 94 causes this overflowing ice to slide towards pump well 96.

Ice received in the pump well 96 is then pumped by way of peristaltic pump 98 along ice conduit 38 back to the static heat exchanger 30 as already described. In this manner, the static heat exchanger 30 is constantly replacing the melted ice new ice received by way of the ice conduit 38.

The fluid component that has passed through the evaporator module 60 has crystallised salts suspended therein. The salt that has crystalised is the salt having as its eutectic freezing temperature the target temperature to which the evaporator module 60 is cooled.

As the crystallised salts are denser than the remainder of the fluid, the crystallised salts settle in the conical section 90 of the discharge tank 64. In doing so, the crystallised salts are contained to the volume of fluid in the discharge tank 64 extending between the discharge valve 102 and the waste outlet 104.

The discharge valve 102 is periodically opened for set time periods. Ideally, the set time period is no longer than the amount of time that it would take to discharge the volume of fluid in the discharge tank extending between the discharge valve 102 and the waste outlet 104.

The fluid discharged through the discharge valve 102 is directed to the filter 112 by way of the first solid conduit 110. The filter 112 operates to separate the crystallised salts from the remainder of the fluid. The crystallised salts are then conveyed to the salt dryer 118 by way of the second solid conduit 116. The remainder of the fluid, with any unfiltered salts suspended therein is then conveyed back to the third conduit 56 to mix with the pre-cooled brines to be reprocessed.

As the invention is considered to be most efficient when dealing with super-saline brines, it is important that the remainder of the fluid directed back to the third conduit 56 does not dilute the pre-cooled brines. However, as the intent of the invention is to also separate out as much fluid in ice form as possible, the remainder of the fluid should also be super-saline, although possibly not to the same concentration as the pre-cooled brines.

In a similar manner, the amount of time that the discharge valve 102 is open is critical. If the discharge valve 102 is open for too long, the crystallised salts delivered to the filter 112 may be excessively diluted.

When fluid is not being discharged by way of the discharge valve 102, it is accumulating in the discharge tank 64. If this fluid accumulates such to the point that it exceeds the waste outlet 104, the waste outlet 104 operates as a secondary discharge point. Fluid discharged by way of the waste outlet 104 is conveyed by way of waste conduit 106 to a waste processor 108.

Crystallised salts received by the salt dryer 118 are dried in a manner as would be readily known to the person skilled in the art before being delivered as an end product to a salt processor for final processing.

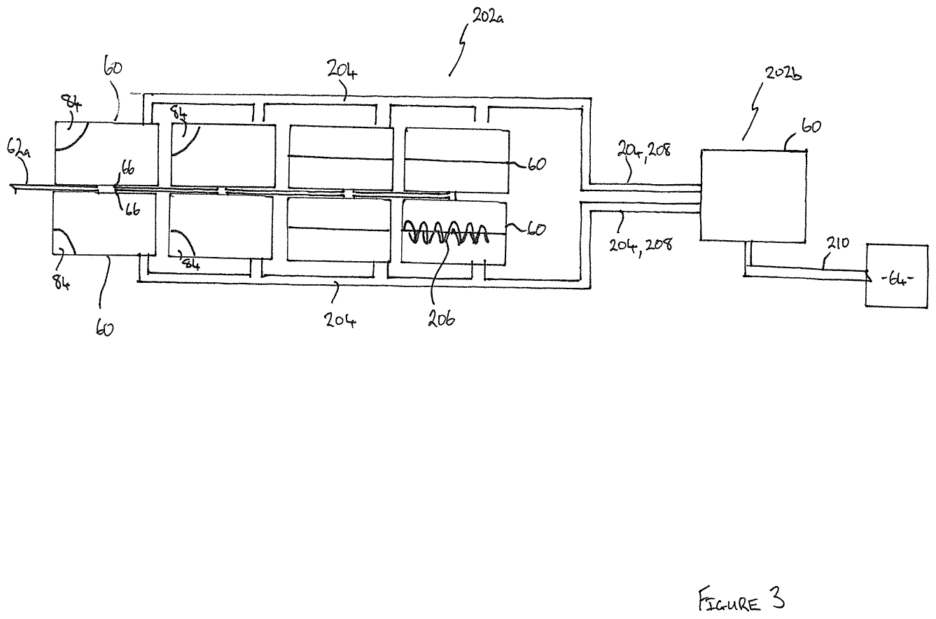

In accordance with a second embodiment of the invention, where like numerals reference like parts, there is a method of treating brines 200. The method of treating brines 200 is identical to the method 10 as described in the first embodiment, with the exception of the evaporation circuit 58 which is replaced with evaporation circuits 202a, 202b. The variation in the evaporation circuits is shown in FIG. 3.

Evaporation circuit 202a is similar to evaporation circuit 58 in that it includes a main feed line 62a that delivers mixed-pre-cooled brine to a plurality of evaporator modules 60. However, in this embodiment, each evaporator module 60 is also connected to a discharge line 204.

The slurry means 70 of the evaporator modules 60 used in this second embodiment differs from the first embodiment in that the static walls 72 are omitted in favour of a water screw 206, also known as an Archimedes screw.

The discharge line 204 operates to convey the slurried brines from evaporation circuit 202a to evaporation circuit 202b. In doing so, the single discharge line 204 of evaporation circuit 202a becomes the main feed line 208 of evaporation circuit 202b.

The evaporator modules 60 of evaporation circuit 202b are of identical construction to those of evaporation circuit 202a. In the same manner, each evaporation module 60 of evaporation circuit 202b is connected to a single discharge line 210. The single discharge line 210 acts as the final conduit for the slurried brines to the discharge tanks 64.

This embodiment of the invention will now be described in the context of its intended use, but as limited to the operation of evaporation circuits 202a, 202b. All other elements of this embodiment operate in the same manner as the first embodiment described above.

As in the first embodiment, on initiation of each evaporator circuit 202a, 202b, refrigerant is dispensed by the respective refrigerant injectors 84 into the space between the internal wall 80 and external wall 82. In this embodiment, the refrigerant used is a refrigerant gas. As with the first embodiment, refrigerant is able to exit the space between the internal wall 80 and external wall 82 by way of refrigerant discharge port 86 so as to allow for new refrigerant to be injected.

The refrigerant interposed between the internal wall 80 and the external wall 82 emanates cold into the area defined by the internal surface 73 of the respective evaporator module 60. However, in this embodiment the desired cooling temperature applied by refrigerant to the evaporator modules 60 of evaporation circuit 202a differs from the desired cooling temperature applied by refrigerant to the evaporator modules of evaporation circuit 202b. Furthermore, the desired cooling temperature applied to evaporator modules 60 of evaporation circuit 202a represents a first eutectic freezing temperature that is lower than a second eutectic freezing temperature (being the desired cooling temperature applied to evaporator modules 60 of evaporation circuit 202b).

Brines passing through the evaporator modules 60 are first received between spirals 212. As the water screw 206 is rotated about its central axis Y-Y, these spirals 212 also rotate, conveying the brines towards the discharge end 74. As with the first embodiment, while being conveyed towards the discharge end 74 the cooling effect of the refrigerant as applied to the area defined by internal surface 73 transforms the brines into a slurry.

The brines, in slurry form, that arrive at the discharge end 74 are then subject to gravitational forces. These forces cause the slurried brines to drop towards the sloped side 78. The angular nature of the sloped side 78 ensures that the slurried brines are channelled towards the discharge line 204, 210 to which the evaporator module 60 is connected.

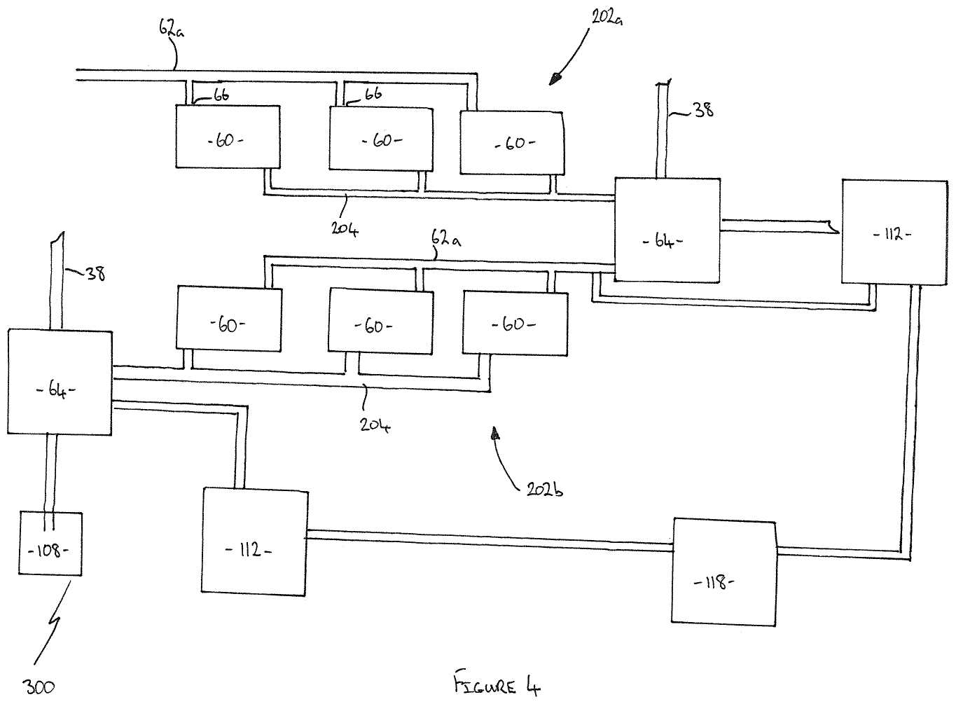

In accordance with a third embodiment of the invention, where like numerals reference like parts, there is a method of treating brines 300. The method of treating brines 300 is identical to the method 200 as described in the second embodiment, with the exception of the makeup of the evaporation circuits 202a, 202b. The variation in the evaporation circuits is shown in FIG. 4.

Specifically, in this third embodiment, evaporation circuit 202a is modified such that discharge line 204 delivers slurried brine to a discharge tank 302. Discharge tank 302 is of identical construction to discharge tank 64.

Discharge valve 102 operates to deliver crystallised salts suspended in fluid to an additional first solid conduit 304. As with the first solid conduit 110, the additional first solid conduit 304 conveys the fluid with suspended crystallised salts to an additional filter 306.

The additional filter 306 is identical to filter 112. However, the remainder of the fluid, with any unfiltered salts suspended therein is conveyed by a conduit 308 that joins up with the main feed line 208 of the evaporation circuit 202b.

In a similar manner, fluid that exits the discharge tank 302 by way of the waste outlet 104 is conveyed by a conduit 310 that again joins up with the main feed line 208 of the evaporation circuit 202b. In doing so, the only elements of the brines that are not subjected to processing by evaporation circuit 202b is the crystallised salts extracted by way of the additional filter 306 and the ice that overflows into the pump well 96.

As the operation of this third embodiment involves a variation on the second embodiment, the function of which has already been described above, and as shown in the Figures, the applicant assumes that the person skilled in the art would have ready knowledge of how to implement this third embodiment without further comment.

This arrangement of the evaporation circuits 202 in the second and third embodiments according to their eutectic freezing temperatures is important as it is the applicant's belief that it is not possible to extract mineral salts of lower eutectic freezing points from brines if the brines include mineral salts having higher eutectic freezing points. To put it another way, the applicant believes that the mineral salt in brines having the lowest eutectic freezing point operates to prevent crystallisation of mineral salts having higher eutectic freezing points. Thus, any attempt to extract multiple mineral salts from brines must properly order the evaporation circuits 202 according to the eutectic freezing temperature of the mineral salts concerned.

Regardless of the embodiment implemented, it is important to note that the materials used to construct the evaporator module play an important role in the success of the invention. Ideally, the materials should be optimised for heat transfer relative to the brines being processed. In this regard, the applicant believes that stainless steel impregnated, or coated, with graphene as an optimal material.

Similarly, it is to be noted that the intent of this invention is to ensure that the mineral salts delivered to the salt processor for final processing are substantially indistinguishable from the mineral salts it would otherwise receive from evaporation ponds. In this manner, the invention seeks to replace the evaporative process of the prior art with a process of dehydration and eutectic freeze crystallisation.

To ensure that each evaporator module 60 maintains its intended temperature in a stable manner, it is preferable that a temperature control system (not shown) be implemented. The temperature control system obtains temperature readings from at least one sensor distributed about the evaporator module (potentially, internally and in the space between the external wall 80 and the internal wall 82) and determine when to add further refrigerant and the amount of such refrigerant to be added.

It should be appreciated by the person skilled in the art that the above invention is not limited to the embodiments described. In particular, the following modifications and improvements may be made without departing from the scope of the present invention:
The pre-treatment vessel 14 is optional. Alternatively, more than one pre-treatment vessel 14 may be included in the circuit 12.
The pre-treatment vessel 14 may be configured to allow for other pre-treatment options. One such option is capacitive deionization of the brine achieved by passing the brines through a stack of electrode pairs comprising a cathode which attracts positive ions (such as sodium) when a voltage is applied thereto and an anode with attracts negative ions (such as chloride) when a voltage is applied thereto. This capacitive deionization of the brines may be in supplement to chemical pre-treatment of the brine. An alternative option is to dose the brines with chemicals other than acids.
As an alternative, power generated by the hydro power generator may be stored in a battery for use in powering elements of the circuit 12 or for other on-site uses.
The central longitudinal axis of the evaporator modules 22 may be aligned either horizontally or vertically.
The various elements of the circuit 12 may be controlled locally, i.e. on-site, or remotely. These control systems may be automatic but acting independent of each other, or automatic as part of a larger control system. Alternatively, the systems may be manually controlled in some manner by an operator.
The Pelton wheel 20 may be replaced with other mechanisms that can provide the necessary kinetic energy that allows the hydro power generator to produce electricity. For instance, the Pelton wheel 20 may be replaced with a turbine.
The term “conduit” as used to describe physical structures in the various embodiments must be interpreted broadly with reference to the nature of the element to be conveyed. As an example, where the element to be conveyed is a fluid, the conduit might take the form of pipe work. Conversely, where the element to be conveyed is a salt, the conduit might take the form of a conveyor.
While the invention as described can be used to any scale, the applicant has a preference to scale at least the evaporator modules 60 to a standard form factor to facilitate modularisation. In this manner, evaporator modules 60 can be added or removed to a structure (not shown) used to house an evaporator circuit 58, 202.
In a variation of the configuration described in the previous paragraph, each evaporator circuit 58, 202 is housed within a first structure and a second structure (not shown). The first structure houses the evaporator modules 60, while the second structure houses its discharge tank 64. Ideally, the first and second structures are of commensurate, if not identical, physical dimensions. Furthermore, the first and second structures adopt a common interface to allow for the flow of brines from one structure to another, as well as allow for other structures including other components as described above or yet new components, and which adopt the common format, to be implemented easily as required.
The slurry means 70 described in the first embodiment may be implemented in the second embodiment and vice versa.
The slurry means 70 used in any of the above embodiments may differ from those described. As examples, the slurry means 70 may take the form of scrapers or a bubbling gas introduced into the slurry.
Projection 76 may be omitted or modified depending on the slurry means 70 employed.
The refrigerant described in the first embodiment may be implemented in the second embodiment and vice versa.
As an alternative to injecting the refrigerant into the space between the external wall 80 and the internal wall 82 of the evaporator module the refrigerant may be directly added to the brines as the manner by which the brines are cooled to the desired eutectic freezing point temperature.
The open top 92 and sloped launder 94 arrangement of the discharge tanks 64, 302 described above may be replaced with other mechanisms which allow ice that rises to the top of the discharge tanks 64, 302 to be removed therefrom and delivered back to the static heat exchanger 30.
Similar to the third embodiment, the remainder of the fluid having unfiltered salts suspended therein after passing through a filter 112 may be directed to a further discharge tank 64, 302. Fluid that exits a discharge tank 302 by way of the waste outlet 104 may also be directed to the next discharge tank 64, 302 provided in series. In such configurations, it is only the fluid that exits the discharge tank 302 by way of the waste outlet 104 of the final discharge tank 64, 302 in the series which is directed to the waste processor 108 by way of waste conduit 106.
The opening of discharge valve 102 may operate at predetermined time intervals. Alternatively, the opening of discharge valve 102 may be based on detection of fluid in the discharge tank 64, 302 by a level sensor (not shown).
The second and third embodiment may be similarly modified to include any number of evaporation circuits 202 as may be desired.
In configurations that employ multiple evaporation circuits 202, additional cooling means may need to be inserted in-line between the circuits 202 to compensate for the exothermic reactions that take place therein.
Power generated by the hydro power generator may be used to power the processes by which hydrogen may be split from the brines.
To prevent icing of the brines in the conduit, conduits may have de-icing means as would be readily known to the person skilled in the art. Alternatively, the problem of icing of the brines may be dealt with through the use of additional pumps that are intended to keep the brines from being in a static place for a time that would allow such icing to take place.
Additional valves may be incorporated into the system to control elements of the process. For instance, a valve may be incorporated into the pre-treatment vessel 16 to ensure that the brines remain in the pre-treatment vessel 16 for a set period of time.
While the embodiments describe an arrangement where each evaporator module 60 is paired with its own discharge tank 64, in alternative arrangements a discharge tank 64 may be paired with multiple evaporator modules 60.
A baffle may be installed at the point where the slurried brines enter the discharge tank 64.
The discharge tanks 64 may be seeded with ice.
The compensatory pump 22 may be omitted in situations where the brine is pumped from its source at a velocity in excess of intended operating velocities. In such an arrangement, the velocity lost by the brines as it passes the Pelton wheel 20 assists in reaching the intended operating velocities.
In an alternative configuration, the discharge tank 64 may be reconfigured so as to have a central conduit. The central conduit terminates at a position lower than the open top 92, such that the ice component that floats to the top of the discharge tank overflows into the central conduit which then transfers it towards the pump well 96. In a further variation of this alternative configuration, the central conduit may be able to be raised or lowered to facilitate draining of the ice collar.
Apparatus used in performing any of the methods 10, 200, 300 may be coated with a super-hydroscopic coating to minimise scaling and facilitate an easier transfer of ice.

It should be further appreciated by the person skilled in the art that the invention is not limited to the embodiments described above. Additions or modifications described, where not mutually exclusive, can be combined to form yet further embodiments that are considered to be within the scope of the present invention.

1.-20. (canceled)

21. A method of treating brines comprising the steps of:
pre-cooling the brines using an indirect cooling method;
further cooling the brines in a vessel using a refrigerant to a first temperature equal to a eutectic freezing point of a first mineral salt suspended in the brines so as to transform the brines into a first iced slurry;
conveying the brines and first iced slurry at least partly through the vessel used to further cool the brines by way of a water screw so as to prevent the first iced slurry from solidifying in place;
separating ice from the first iced slurry in a separator, the separated ice being returned for use as part of the pre-cooling step;
filtering the remainder of the first iced slurry to recover crystallised mineral salts suspended therein.

22. The method of treating brines according to claim 21, where a bubbling gas is introduced into the brines so as to prevent the first iced slurry from solidifying in place.

23. The method of treating brines according to claim 21, further including the step of applying a super-hydrophobic coating to the internal surface of the vessel.

24. The method of treating brines according to claim 21, further including a step of pre-treating the brines.

25. The method of treating brines according to claim 24, where the step of pre-treating the brines involves chemical treatment of the brines.

26. The method of treating brines according to claim 24, where the step of pre-treating the brines involves capacitive deionization of the brines by passing the brines through a stack of electrode pairs.

27. A method of treating brines according to claim 21, further comprising the subsequent steps of:
additionally cooling the brines in the vessel using a refrigerant to a second temperature equal to a eutectic freezing point of a second mineral salt suspended in the brines so as to transform the brines into a second iced slurry;
conveying the brines and second iced slurry through the vessel used to further cool the brines so as to prevent the second iced slurry from solidifying in place;
separating the ice from the second ice slurry in the separator, the separated ice being returned for use as part of the pre-cooling step; and
filtering the remainder of the second ice slurry to recover crystallised mineral salts suspended therein, and
wherein, the eutectic freezing point of the first mineral salt is greater than the eutectic freezing point of the second mineral salt.

28. The method of treating brines according to claim 21, further including the step of extracting hydrogen from the brines by electrolysis.

29. The method of treating brines according to claim 21, further including at least one step of drying the recovered crystallised mineral salts.

30. A system of treating brines comprising:
a static heat exchanger comprising a container having a hollow internal area and at least one conduit passing therethrough;
an evaporator having an inner wall and a water screw;
refrigerating means;
a discharge tank; and
a filter,
wherein brines passing through the at least one conduit are pre-cooled by ice delivered to the hollow internal area before being delivered to the evaporator and where the refrigerating means operates to deliver refrigerant to the evaporator that cools the area defined by the inner wall to a first temperature equal to a eutectic freezing point of a mineral salt suspended in the brines and thereby transform the brines into an iced slurry; and where, the iced slurry is at least partly conveyed through the evaporator to the discharge tank by way of the water screw so as to prevent its solidification for ultimate delivery to the discharge tank where ice is separated from the iced slurry for delivery to the hollow internal area of the static heat exchanger, the remainder of the iced slurry is filtered by the filter to recover crystallised mineral salts suspended therein.

31. The system of treating brines according to claim 30, further including injector means, the injector means operable to introduce a bubbling gas into the brines conveyed through the evaporator, the bubbling gas operable to prevent the first iced slurry from solidifying in place.

32. The system of treating brines according to claim 30, where the internal surface of the vessel is treated with a super-hydrophobic coating.

33. The system of treating brines according to claim 30, further including a pre-treatment vessel incorporating a chemical doser, the chemical doser operable to pre-treat brines passing through the pre-treatment vessel with an acid before delivery to the static heat exchanger.

34. The system of treating brines according to claim 30, further including a hydro electric generator, the hydro electric generator operable to generate power from brines before the brines are delivered to the static heat exchanger and the power so generated is used by an electrolytic cell to separate hydrogen in the brines by way of electrolysis.

35. The system of treating brines according to claim 30, further including at plurality of evaporation circuits, each evaporation circuit comprising at least one evaporator and at least one discharge tank grouped, each evaporator circuit adapted to cool the brine that is conveyed therethrough to a eutectic freezing point of a differing mineral salt suspended in the brines and filter out the crystallised mineral salts and/ice generated in each evaporator circuit and where the evaporation circuits are arranged according to the intended eutectic freezing point of the mineral salt to be processed such that the brines conveyed through the evaporation circuit having the greatest intended eutectic freezing point first and the evaporation circuit having the lowest intended eutectic freezing point last.

36. The system of treating brines according to claim 30, where the evaporator has an outer wall, and the refrigerating means delivers refrigerant to the area between the inner wall and the outer wall.

37. The system of treating brines according to claim 30, where the refrigerating means delivers refrigerant to the evaporator for direct injection into the brines conveyed therethrough.

38. The system of treating brines according to claim 30, where the inner wall is coated with a super hydrophobic coating.

39. The system of treating brines according to claim 30, where the discharge tank has a sloped launder and a peristaltic pump, the sloped launder operable to convey ice separated by the discharge tank to the peristaltic pump, the peristaltic pump operable to deliver the separated ice to the hollow internal area of the static heat exchanger.

40. The system of treating brines according to claim 30, where the discharge tank has a discharge valve for discharging the remainder of the ice slurry to the filter and a level sensor, where, when the level sensor detects that the ice slurry in the discharge tank exceeds a predetermined level, the level sensor controls the discharge valve to move from a closed to an open position until the level sensor no longer detects that the ice slurry exceeds the predetermined level.
